(19) United States
(12) Patent Application Publication
(10) Pub. No.: US 2007/0232170 A1
(43) Pub. Date: Oct. 4, 2007

(54) Polyester and modified fluoropolymer blends

(76) Inventors: Kenneth B. Atwood, Hendersonville, TN (US); Michael Joseph Brown, Wilmington, DE (US); David C. Urian, Pennsville, NJ (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/644,311

(22) Filed: Dec. 22, 2006

Related U.S. Application Data
(60) Provisional application No. 60/753,316, filed on Dec. 22, 2005.

(51) Int. Cl. D03D 15/00; C08F 283/00; C08F 8/00; C08G 63/00

(52) U.S. Cl. 442/200; 525/418; 525/55; 525/64

(57) ABSTRACT

Disclosed are blends of a polyester resin and fluoropolymer resin having compatibilizing side groups, such as maleic anhydride. Also disclosed are fibers and fabrics containing that composition. The fabrics are particularly suitable for use in belts in papermaking machines.

### BACKGROUND OF THE INVENTION

1. Field of the Invention

This invention relates to a composition comprising a blend of a polyester resin and modified fluoropolymers that have compatibilizing side groups. The invention also relates to articles, fibers and fabrics containing that composition. The fabrics are particularly suitable for use in belts for papermaking.

2. Description of the Related Art

Polyester, such as polyethylene terephthalate (PET), monofilaments have traditionally been used in the papermaking industry, frequently woven into support belts or fabrics for transporting and dewatering paper sheets produced by papermaking machines. The belts typically have complex weave patterns with many pores in them to allow for removal of water from the forming paper sheet. While in use, these fabrics are subjected to demanding conditions that chemically, physically, and mechanically degrade the polyester monofilaments from which the fabrics are made. Specifically, these fabrics are typically subjected to thermal, hydrolytic and abrasive conditions. In addition, papermaking belts are subject to contamination from adhesion and accumulation thereon of material comprising filling material, sizing agents, paper strength reinforcing agents, adhesives especially from recycled paper products, and various other papermaking raw materials incorporated in the paper pulp. This contamination limits the duration of safe use and the conditions of effective use of the belts, and requires the belts to be cleaned at frequent intervals. The contaminants are generally removed with pressurized water sprays, but not all the contaminants can be removed at each cleaning. As a result, as time goes on, the time between cleanings becomes shorter and shorter until the paper manufacturer determines it is economical to replace the belt. This cleaning downtime reduces productivity and increases costs.

Attempts have been made to improve the hydrolytic stability of PET. For example, U.S. Pat. No. 3,975,329 indicates that the hydrolytic as well as the thermal stability of PET can be improved by melt extruding this standard polyester resin in the presence of a significant amount of a carbodiimide.

It has also been known in the art to blend certain fluoropolymers with various thermoplastic resins to achieve a number of desired results. For example, U.S. Pat. No. 3,005,795 teaches the blending of polytetrafluoroethylene (PTFE) in powder form with various thermoplastic polymers such as methacrylate polymers, styrene polymers, and polycarbonates. U.S. Pat. No. 3,294,871 teaches the blending of PTFE in latex form with various thermoplastic polymers including those mentioned above. However, in both of these patents, the blends include finely divided microfibrous particles of PTFE, which are not suitable for producing polyester monofilaments, as discussed below.

U.S. Pat. No. 3,723,373 teaches the addition of a PTFE emulsion to polyethylene terephthalate (PET) to achieve a material which has greater elongation and improved impact strength. The PTFE emulsion is merely PTFE in the form of a latex dispersion or emulsion with water, mineral oil, benzene or the like. Accordingly, the PTFE emulsion also includes particles of about 0.1 micron to about 0.5 microns in size comprising about 30 to 80% of the emulsion. The PTFE emulsion forms about 0.1 to 2.0 weight % of the blend, based upon the weight of the PET.

Attempts have been made to improve the abrasion resistance of monofilaments produced from PET while also improving the hydrolytic stability of the monofilament. For example, U.S. Pat. No. 5,378,537, teaches a PET monofilament stabilized by the addition of an unaltered carbodiimide compound in the range from 0.005 to 1.5 weight % and a fluoropolymer in an amount in the range from 0.01 to 30 weight %.

U.S. Pat. Nos. 5,378,537; 5,460,869 and 5,489,467 disclose polymer blends comprising polyester resin, a melt extrudable fluoropolymer resin and a hydrolytic stabilizing agent.

Fibers comprising polyester blended with 10 weight % of polyvinylidene fluoride (PVDF) are known for soil-release fabrics for papermaking belts.

Prior monofilament melt-spun fibers comprising blends of polyester and fluoropolymers with sufficient fluoropolymer to provide low contaminant adhesion suffer from poor physical properties (e.g. tensile strength and abrasion resistance).

Microscopic examination of fibers made from melt-blended polyester and ethylene tetrafluoroethylene (ETFE) shows relatively large droplets of fluoropolymer (about 5 microns in diameter), indicating an inefficient distribution of fluoropolymer in the polyester. That coupled with low loading levels results in little fluoropolymer on the surface of the fibers. Additionally, the fluoropolymer particles were not well adhered to the polyester matrix. The poor adhesion allows the fluoropolymer particles to separate from the polyester matrix, leaving voids in the fiber. These voids contributed to poor physical properties.

Polyester blends with polytetrafluoroethylene (PTFE) in powder form also suffer from poor adhesion and physical properties due to difficulties in achieving high-quality dispersion.

Fluoropolymers grafted with compatibilizing (reactive) side groups are disclosed in U.S. Pat. Nos. 5,576,106 and 5,756,199. They have been described as adhesives and/or compatibilizing agents for joining dissimilar materials, particularly laminate structures.

It is desirable for materials used in a papermaking belt to have reduced adhesion of contaminants to the belt so that it can be more thoroughly cleaned. Thus, a papermaking fabric woven from extruded polyester monofilaments that exhibit improved resistance to contamination and improved abrasion resistance and hydrolytic stability compared to fabrics made from conventional polyester monofilaments is desirable. Therefore, a need exists for a fabric polyester monofilament that is hydrolytically stable and that demonstrates an improved resistance to contamination (e.g. soiling) and abrasion.

### SUMMARY OF THE INVENTION

The present invention provides a composition comprising

(a) at least about 45 weight % of a polyester resin;

(b) up to about 55 weight % of a fluoropolymer component comprising at least one modified fluoropolymer, said modified fluoropolymer being a fluoropolymer having compatibilizing side groups, and optionally comprising at least one non-modified fluoropolymer, said non-modified fluoropolymer being one that does not have compatibilizing side groups, the weight percentages based on the total weight of the composition; optionally comprising (c), (d), (e), or combinations thereof, wherein

(c) is at least one additional polymeric resin that is not a polyester resin, a modified fluoropolymer or a non-modified fluoropolymer;

(d) is a hydrolytic stabilizer; and

(e) is an inorganic filler.

Of particular note, the composition may comprise a polyester resin that forms a continuous phase and the fluoropolymer component that forms a discrete, or dispersed, phase.

Compatibilizing side groups include carboxylic, sulfonic, and phosphonic acid moieties and diacids, esters, and anhydrides thereof.

The modified fluoropolymer can be prepared by grafting at least one comonomer comprising a compatibilizing side group selected from the group consisting of dialkyl maleate esters, monoalkyl maleate esters, maleic anhydride, halogen-substituted maleic anhydrides, itaconic anyhdride, citraconic anhydride, glutaconic anhydride, and ester-functional fluoro(vinyl ether) or styrene comonomers onto a fluoropolymer.

Alternatively, the modified fluoropolymer can be prepared by copolymerization of at least one comonomer comprising a compatibilizing side group selected from the group consisting of dialkyl maleate esters, monoalkyl maleate esters, maleic anhydride, halogen-substituted maleic anhydrides, itaconic anhydride, citraconic anhydride, glutaconic anhydride, and ester-functional fluoro(vinyl ether) or styrene comonomers with at least one fluorine-containing comonomer.

Preferably, the compatibilizing side groups are derived from maleic anhydride.

Other compatibilizing side groups include epoxy-functionalized moieties, including ones derived from glycidyl-containing moieties such as glycidyl acrylate or glycidyl methacrylate or glycidyl vinyl ethers of from 1 to 10 carbon atoms (e.g., glycidyl vinyl ether); or mono-epoxy substituted di-olefins of from 4 to 12 carbon atoms.

The composition described above optionally comprises at least one fluoropolymer that does not have compatibilizing side groups (“non-modified fluoropolymer”). The modified and non-modified fluoropolymers may be pre-compounded and then compounded with the polyester resin; or the polyester resin, the modified fluoropolymer and the non-modified fluoropolymer may be compounded together in a single step. Preferably, the composition comprises at least about 45 weight % of a polyester resin and up to about 55 weight % of a fluoropolymer resin that comprises at least one modified and at least one non-modified fluoropolymer, weight percentages being based on total weight of composition. The fluoropolymer component preferably comprises about 10 weight % or more modified fluoropolymer and up to about 90 weight % non-modified fluoropolymer, weight percentages being based on total weight of the fluoropolymers.

The polyester composition or blend described above optionally further comprises at least one additional polymeric resin that is other than the polyester resin, the modified fluoropolymer and the non-modified fluoropolymer (if present). Of note are polymeric resins selected from the group consisting of polyethylene homopolymers and copolymers, polyethylene comprising compatibilizing side groups derived from maleic anhydride or epoxide, ethylene α,β ethylenically unsaturated carboxylic acid copolymers and ionomers thereof, polyamides and ethylene/alkyl (meth)acrylate copolymers.

This invention also provides articles comprising the composition described above. One embodiment is a monofilament fiber comprising the composition described above.

Another embodiment is a fabric comprising the composition described above. Of note is a fabric formed from a plurality of woven monofilament fibers comprising the composition described above. The polyester fabric exhibits improved resistance to contamination and abrasion as compared to fabrics woven from monofilaments containing blends of polyethylene terephthalate and conventional (non-modified) fluoropolymer resins.

A specific article is a papermaking belt comprising a fabric formed from a plurality of woven monofilament fibers comprising the composition described above.

### DETAILED DESCRIPTION OF THE INVENTION

All publications, patent applications, patents, and other references mentioned herein are incorporated by reference in their entirety. Unless otherwise defined, all technical and scientific terms used herein have the same meaning as commonly understood by one of ordinary skill in the art to which this invention belongs. In case of conflict, the present specification, including definitions, will control.

Except where expressly noted, trademarks are shown in upper case.

Although methods and materials similar or equivalent to those described herein can be used in the practice or testing of the present invention, suitable methods and materials are described herein.

“Copolymer” means polymers containing two or more different monomers. The terms “dipolymer” and “terpolymer” mean polymers containing only two and three different monomers respectively. The phrase “copolymer of various monomers” means a copolymer whose units are derived from the various monomers.

The term “(meth)acrylic acid” means methacrylic acid and/or acrylic acid. Likewise, the term “(meth)acrylate” means methacrylate and/or acrylate.

The term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

The term “or”, as used herein, is inclusive; more specifically, the phrase “A or B” means “A, B, or both A and B”. Exclusive “or” is designated herein by terms such as “either A or B” and “one of A or B”, for example.

In addition, the ranges set forth herein include their endpoints unless expressly stated otherwise. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed.

When materials, methods, or machinery are described herein with the term “known to those of skill in the art”, or a synonymous word or phrase, the term signifies that materials, methods, and machinery that are conventional at the time of filing the present application are encompassed by this description. Also encompassed are materials, methods, and machinery that are not presently conventional, but that will have become recognized in the art as suitable for a similar purpose.

Finally, all percentages, parts, ratios, and the like set forth herein are by weight, unless otherwise stated in specific instances.

Thermoplastic compositions are polymeric materials that can flow when heated under pressure. Melt index (MI) is the mass rate of flow of a polymer through a specified capillary under controlled conditions of temperature and pressure. Melt indices reported herein are determined according to ASTM 1238 at 190° C. using a 2160 g weight, with values of MI reported in grams/10 minutes.

Composition

This invention is directed to a composition comprising polyester resin as described below and at least one modified fluoropolymer copolymer as described below (that is, a fluoropolymer copolymer having compatibilizing side groups), and articles, including fibers, fabrics and papermaking belts comprising that composition. The modified fluoropolymer content based on total weight of polyester and fluoropolymer in the composition is at least 0.01 weight %, preferably at least about 0.5 weight %. The modified fluoropolymer may be up to 55 weight % of the composition, but embodiments include weight percentages from a lower limit of about 0.5, 1 or 3 weight % to an upper limit of about 7, 10 or 15 weight % of the composition. In another embodiment, the modified fluoropolymer may be from about 15 to about 45 or 55 weight % of the composition.

The polyester resin is at least 45 weight % of the composition and may be present in up to 99.99 weight % of the composition. For example, the polyester may be present from a lower limit of 45, 55, 80, or 85 weight % to an upper limit of 97, 99 or 99.5 weight %. In some embodiments, the polyester resin is present in about 60 to 90 weight % or about 65 to 97 weight % of the composition. In these embodiments, the polyester resin forms a continuous phase in the composition and the modified fluoropolymer copolymer is dispersed in the continuous polyester resin phase.

The composition may also comprise at least one non-modified fluoropolymer as described below (that is in brief, a fluoropolymer resin that does not have compatibilizing side groups), and articles, fibers and fabrics comprising that composition. The modified fluoropolymer and the non-modified fluoropolymer provide a fluoropolymer component of the composition and are dispersed in a continuous polyester resin phase. The modified fluoropolymer and the non-modified fluoropolymer preferably are blended together to form the fluoropolymer component that is then blended with the polyester resin to form the composition. In this embodiment, the modified and non-modified fluoropolymers form a single dispersed fluoropolymer phase. Alternatively, the modified fluoropolymer, the non-modified fluoropolymer and the polyester resin may be compounded together in the same process step. In this embodiment, the modified and non-modified fluoropolymers may form distinguishable dispersed fluoropolymer phases. In the composition, the total fluoropolymer component may be up to 55 weight % of the composition, but embodiments include compositions with total fluoropolymer component from a lower limit of about 3, 7 or 10 weight % to an upper limit of 35, 40 or 55 weight %. The modified fluoropolymer content based on total weight of the composition is at least 0.01 weight %, preferably at least about 0.5 weight %, but alternative embodiments include weight percentages based on the total composition of about 0.5 to 7 weight %, about 1 to 15 weight % or about 2 to 10 weight % of modified fluoropolymer resin. The modified fluoropolymer may be about 10 weight % or more and the non-modified fluoropolymer may be up to about 90 weight % of the total weight of the combined fluoropolymer components. In some embodiments, the modified fluoropolymer may be about 10, 20, 30, 40, 50 or 60 weight % of the fluoropolymer component (for example, about 10 to 40 or about 20 to 60 weight % based on total fluoropolymer component weight).

Other components, such as hydrolytic stabilizing agents as described below, inorganic fillers as defined below, and anti-oxidants may optionally be included in the above compositions. The optional hydrolytic stabilizing agent may be added to a polyester composition in amounts of about 0.005 to about 2 parts per hundred parts of the blend (the amount of hydrolytic stabilizing agent is in addition to the polymeric components of the blend and is not included in the weight percentages for the blend), preferably, from about 0.01 parts to about 1.5 parts per hundred. The optional inorganic filler materials may be added to the polyester composition in amounts of about 0.005 to about 20 parts per hundred parts of the blend (the amount is in addition to the polymeric components of the blend and is not included in the weight percentages for the blend), preferably, from about 0.01 parts to about 15 parts per hundred.

The inorganic filler is preferably first incorporated into the fluoropolymer resins and then melt-blended with the polyester resin.

While not intending to be limiting, it appears that including the modified fluoropolymer in the compositions facilitates production of high-quality dispersions. The dispersed components, particularly the modified fluoropolymer, are dispersed in the continuous polyester phase as particles having diameters of less than 2 microns, notably from 0.1 to 1 micron. The dispersed particles are strongly anchored to the matrix formed by the continuous polyester resin phase. Also, it has been found that the above compositions can be spun into fibers that have excellent physical properties at much higher fluoropolymer loading levels than are possible by dispersing non-modified fluoropolymers alone. Even after the fibers made using the compositions are stretched, there is no separation at the polyester/fluoropolymer interface. Fiber properties such as tensile strength, abrasion resistance, hydrolysis resistance and heat aging are comparable to standard polyester fibers, while the fluoropolymer modification provides for low contaminant adhesion and consequent soil release.

Polyester Resins

Useful polyester polymer resins include polymers derived from condensation of diols and diacids (or derivatives thereof that are suitable for forming fibers. Of note is a polyester comprising an aromatic dicarboxylic acid as the main acid component. Examples include polyethylene terephthalate, polypropylene terephthalate, polytetramethylene terephthalate (polybutylene terephthalate), polycyclohexane-dimethylene terephthalate and polyethylene-2,6-naphthalene dicarboxylate. These polyesters may also be copolymers copolymerized with either another alcohol and/or another dicarboxylic acid as additional components. Part of the dicarboxylic acid moiety thereof may be substituted by isophthalic acid, 2,6-naphthalenedicarboxylic acid, 1,4-cyclohexanedicarboxylic acid, adipic acid, sebacic acid, dimer acid, and isophthalic acid containing a metal salt of sulfonic acid as a substituent, such as 5-sodium sulfoisophthalate, for example. Part of the glycol moiety thereof may be substituted by diethylene glycol, neopentyl glycol, 1,4-cyclohexane diol, 1,4-cyclohexanedimethanol, polyalkylene glycol, 1,2 propanediol, 1,3-propanediol (trimethylene glycol) and 1,4-butanediol, for example. Use of a small amount of a chain-branching agent such as pentaerythritol, trimethylol propane, trimellitic acid, trimesic acid, or boric acid is also contemplated. Mixtures of two or more of these polyesters also may be used. The term “polyester” when used herein is used generically to refer to any or all of the polymers described above. The polyester preferably has polyethylene terephthalate (PET), polypropylene terephthalate (PPT) and/or polybutylene terephthalate (PBT) as main components thereof, and a particularly preferred polyester comprises polyethylene terephthalate as a single main component.

Preferably, the polyesters have an intrinsic viscosity (IV) of between 0.5 and 1.2 (determined using an 8% solution in o-chlorophenol at a temperature of 25° C.).

Preferred is a composition wherein the polyester comprises polyethylene terephthalate, polypropylene terephthalate or polybutylene terephthalate as the continuous phase, and particularly preferred is a composition wherein the polyester comprises polyethylene terephthalate as the continuous phase.

Polyesters and methods to prepare them are well known in the art. As mentioned, the polyester monofilaments preferably include a polyethylene terephthalate (PET) resin. Notably, PET resins have a melt temperature below 260° C. (500° F.) and may be formed from ethylene glycol by direct esterification of terephthalic acid or by catalyzed ester exchange between ethylene glycol and dimethyl terephthalate. However, other processes for producing PET may also be available and are well known in the art. PET is suitable for use in forming monofilaments because it has dimensional stability and low moisture regain, preferred in forming and dryer fabrics.

Examples of PET resins are those produced by E. I. du Pont de Nemours and Company, of Wilmington, Del. (DuPont), under the trademark CRYSTAR. These particular PET resins have a melt temperature of about 257° C. (495° F.) and an intrinsic viscosity of from about 0.55 to about 0.97. Use of a PET resin with an intrinsic viscosity of about 0.72 to about 0.85 will facilitate blending and extrusion. Nonetheless, the use of a PET resin having other intrinsic viscosities should not be precluded.

Preferably, the polymer blend contains from about 45 to about 97 weight % of PET.

Non-Modified Fluoropolymers

The non-modified fluoropolymer may be any compound as long as it contains a fluorine atom in the molecular unit thereof. The non-modified fluoropolymers include fluoropolymers having fluorine atoms mainly in the main chain of polymer molecule such as random copolymers having tetrafluoroethylene and ethylene as main components thereof (ETFE), polychloro-trifluoroethylene (PCTFE), polyvinylidene fluoride (PVdF), vinylidene fluoridetetrafluoroethylene copolymer (2F-4F), polytetrafluoroethylene (PTFE), tetrafluoroethylene-perfluoroalkylvinyl ether copolymers (PEA), and tetrafluoroethylene-hexafluoropropylene copolymer (FEP), random or block copolymers of acrylates and/or methacrylates possibly containing a hydroxyalkyl group such as polyperfluoroalkyl acrylate, polyperfluoroalkylmethacrylate, perfluoroalkyl acrylate, and/or perfluoroalkyl methacrylate, and fluoropolymers containing a fluorine atom such as polyesters or polyether polyesters containing an o- or m-perfluoroalkoxyisophthalic acid in at least part of the dicarboxylic acid moiety thereof, for example.

Preferably, the non-modified fluoropolymers are melt processible or melt extruded fluoropolymers. By the term “melt extruded,” it is meant that, in the extrusion process, the fluoropolymers melt and become liquid under standard processing conditions, for example not involving temperatures above about 320° C. (608° F.). Accordingly, the fluoropolymers have a melt temperature below about 320° C. and preferably melt within the normal extrusion operating temperature range of about 170° C. to 320° C. (338 to 608° F.), and even more desirably within the range of about 250° C. to 280° C. Therefore, at normal operating temperatures, the entire blend of polyester resin and fluoropolymer additive will be in the melt phase and is melt processible.

Examples of non-modified fluoropolymers having melt temperatures below about 320° C. include ethylene tetrafluoroethylene (ETFE) copolymers such as those produced by DuPont under the trademark TEFZEL; tetrafluoroethylene hexafluoropropylene copolymers such as those produced by DuPont under the trade name TEFLON FEP; and polyfluoroalkoxy copolymers such as those produced by DuPont under the trade name TEFLON PFA. In addition, polyvinylidene fluoride copolymers and ethylene chlorotrifluoroethylene copolymers may also be suitable fluoropolymers for extrusion purposes, as well as mixtures of the melt extrudable fluoropolymers discussed herein.

All of the fluoropolymers mentioned above melt in the temperature range of about 170° C. to 320° C. (338 to 608° F.), and therefore, are in the liquid phase, along with the polyester resin employed, when extruded at temperatures below about 320° C. Notably, TEFZEL melts between about 245° C. to 280° C. (473 to 536° F.); TEFLON FEP melts within the range of about 260° C. to 285° C. (500 to 545° F.); and TEFLON PFA melts between about 300° C. and 310° C. (572 to 590° F.). Additionally, polyvinylidene fluoride copolymers and ethylene chlorotrifluoroethylene copolymers melt below 320° C.

Among other fluoropolymers cited above, especially among other fluoropolymers having a fluorine atom in the main chain of polymer molecule, ETFE is preferable in that it is readily moldable within the range of melt-molding temperature of the polyester and effectively enhances the ability to resist contamination and hydrolysis.

The ETFE may optionally incorporate therein besides tetrafluoroethylene and ethylene one component selected from among monochlorotrifluoroethylene, perfluoroacrylate, perfluoroalkyl-acrylate, perfluoroalkylvinyl ether, hexafluoropropylene, and vinylidene fluoride in a copolymerized form in an amount of approximately from 0.1 to 10% by weight.

The amount of fluorine present in the ETFE has an upper limit of about 69 weight %, based on the amount of the copolymer consisting of ethylene and tetrafluoro-ethylene at a ratio of 1:1. For good performance in resisting contamination and hydrolysis, the ETFE preferably contains at least 40 weight %, more preferably at least 42 weight %, more preferably at least 46 weight % of fluorine.

Modified Fluoropolymers

The modified fluoropolymers comprise fluoropolymer copolymer resins having compatibilizing side groups. Of note is a composition wherein the fluoropolymer comprising compatibilizing side groups comprises ethylene tetrafluoroethylene.

The compatibilizing side groups are derived from ethylenically unsaturated compounds, typically containing a polar reactive functional group. The compatibilizing side groups may be incorporated in a fluoropolymer by copolymerization of monomers comprising compatibilizing side groups with fluorine-containing comonomers. Compatibilizing side groups may also be incorporated by grafting an ethylenically unsaturated compound onto an existing fluoropolymer such as those described above under heading “Non-Modified Fluoropolymers”. Useful ethylenically unsaturated compounds include acids, e.g., carboxylic, sulfonic, and phosphonic acids, and preferably the diacids, esters, and anhydrides thereof. Examples of such compounds include dialkyl maleate esters such as diethyl maleate, monoalkyl maleate esters (MAMEs) such as monoethyl maleate ester, maleic anhydride, halogen-substituted maleic anhydrides such as dichloromaleic anhydride and difluoromaleic anhydride, itaconic anhydride, citraconic anhydride, glutaconic anhydride, ester-functional fluoro(vinyl ether) or styrene, and the like. It is not necessary that the compound have more than one ethylenically unsaturated group. Maleic anhydride is a preferred grafting compound. Graft fluoropolymers can be prepared according to procedures described in U.S. Pat. Nos. 5,378,537; 5,460,869 and 5,489,467. Of note are graft fluoropolymers comprising compatibilizing side groups derived from maleic anhydride (a maleated fluoropolymer). Of particular note is a graft fluoropolymer derived from the grafting of maleic anhydride to an ETFE base polymer.

Other compatibilizing side groups include epoxy-functionalized moieties, preferably those derived from glycidyl-containing moieties. The glycidyl moiety may be represented by the following formula:

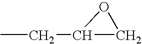

Generally useful glycidyl-containing, epoxy-functionalized fluoropolymers will contain about 0.3 (or about 0.5) to about 3 (or about 4 weight % or about 5 weight %) comonomer containing glycidyl moieties based on the total weight of the epoxy-functionalized fluoropolymer.

Preferred epoxy-functionalized moieties may be represented by the formula —(CH₂CR₃R₄)—, where R₃ is hydrogen or methyl and R₄ is carboglycidoxy (for example, derived from glycidyl acrylate or glycidyl methacrylate) or glycidoxy. The epoxy-containing moiety may also be derived from vinyl ethers of 1 to 10 carbon atoms (e.g., glycidyl vinyl ether) or mono-epoxy substituted di-olefins of 4 to 12 carbon atoms. The R₄ in the above formula includes an internal glycidyl moiety associated with a cycloalkyl monoxide structure; e.g., derived from vinyl cyclohexane monoxide. Preferably, the epoxy-containing side group is derived from glycidyl acrylate or glycidyl methacrylate. Of note are fluoropolymers comprising compatibilizing side groups derived from glycidyl acrylate or glycidyl methacrylate. Of particular note is a graft fluoropolymer derived from the grafting of glycidyl acrylate or glycidyl methacrylate to an ETFE base polymer.

Other epoxy-functionalized moieties include mono-epoxy substituted di-olefins of from 4 to 12 carbon atoms.

When the modified fluoropolymer is melt-blended with polyester and non-modified fluoropolymer, it provides superior properties for the blend. The modified fluoropolymer provides better dispersion and adhesion of the non-modified fluoropolymer to the polyester with which it would otherwise be incompatible. Without being limited by any particular theory, the compatibilizing side groups are believed to chemically interact with the polyester. For example, they may react with nucleophiles present in the polyester to form covalently bonded links. These chemically associated loci allow for improved dispersion of the fluoropolymer out of a relatively few large droplets into numerous, much smaller droplets of the fluoropolymer in the polyester matrix. The chemically attached fluoropolymer provides ongoing strong adhesion for the associated non-modified fluoropolymer, keeping the entire dispersed fluoropolymer droplet anchored to the polyester matrix.

This approach can be employed even if the modified fluoropolymer does not react strongly with polyester by adding small amounts of an additional polymer to which the side groups will react. This secondary material can then be coupled to the polyester using either chemically reactive or non-reactive compatibilization techniques.

It may be desirable to use a modified (grafted) fluoropolymer derived from the same type of non-modified fluoropolymer as that used in the blend. For example, a combination of modified fluoropolymer derived from ETFE and a non-modified ETFE fluoropolymer is useful in the polyester blend. Of particular note is a composition comprising polyethylene terephthalate, an ETFE non-modified fluoropolymer and a modified fluoropolymer derived from the grafting of maleic anhydride to an ETFE base fluoropolymer.

Additional Polymeric Resins

The composition described above optionally further comprises at least one additional polymeric resin other than a polyester resin, a fluoropolymer and a fluoropolymer comprising compatibilizing side groups and articles, including fibers, fabrics and papermaking belts comprising such compositions. When present, the content of the additional polymer in the polyester composition may be from a lower limit of 0.01 weight % or 0.5 weight % to an upper limit of about 8, 10 or 20 weight % based on the total weight of the composition.

Of note are polymeric resins selected from the group consisting of polyethylene homopolymers and copolymers, polyethylene comprising compatibilizing side groups derived from maleic anhydride and epoxide, ethylene α,β ethylenically unsaturated carboxylic acid copolymers and ionomers thereof, polyamides and ethylene/alkyl (meth)acrylate copolymers.

Preferably, these additional polymeric resins are reactive with the polyester and/or the compatibilizing side groups on the modified fluoropolymer (“compatibilizer resins”). The compatibilizer resins preferably form a discontinuous phase dispersed in the continuous polyester resin phase. An embodiment of the composition thus comprises a continuous polyester resin phase with dispersed discontinuous phases of compatibilizer resin and modified fluoropolymer (or a fluoropolymer component comprising modified and non-modified fluoropolymers).

An additional polymeric resin may be a compatibilizer polymer such as polyethylene comprising compatibilizing side groups derived from maleic anhydride and epoxide moieties. These compatibilizing side groups are described more fully above in relation to the modified fluoropolymer. When present in the composition, the compatibilizer polymer is dispersed, preferably in numerous, small particles in the continuous polyester resin phase. The resulting compound may have discrete compatibilizer polymer phases and separate discrete fluoropolymer resin phases dispersed in the continuous polyester phase. The compatibilizer polymer is preferably first melt-blended with the fluoropolymers and then melt-blended with the polyester resin.

The polyethylene comprising compatibilizing side groups can be a graft copolymer or a random copolymer, including an epoxy-containing copolymer such as that available as ELVALOY PTW or ELVALOY AS from DuPont, or maleic anhydride-containing graft copolymers such as those available under the tradenames BYNEL and FUSABOND from DuPont.

A compatibilizer resin of note is an ethylene copolymer is derived from ethylene, n-butyl acrylate, and glycidyl methacrylate.

Of note is a composition comprising at least two additional polymeric resins wherein one additional polymeric resin is a polyethylene comprising compatibilizing side groups derived from an epoxide or maleic anhydride and one additional polymeric resin is a polyamide.

Hydrolytic Stabilizing Agents

The polyester blend described above optionally comprises a hydrolytic stabilizer. Hydrolytic stabilizers of note are carbodiimides.

Examples of carbodiimides include aromatic polycarbodiimides such as 2,4-diisocyanato-1,3,5-tris(1-methylethyl)copolymer with 2,6-diisopropyl diisocyanate and benzene-2,4-diisocyanato-1,3,5-tris(1-methylethyl)homopolymer, also produced by Rhein-Chemie under the tradenames STABAXOL P and STABAXOL P100, respectively. For example, mixtures of these carbodiimides may also be employed. Such mixtures are often premixed, or masterbatched, prior to combining with other resins. For example, STABAXOL P and STABAXOL P100 are combined to form STABAXOL 8059 Masterbatch, which includes 8 weight % of STABAXOL P and 7 weight percent STABAXOL P100. Another example is STABAXOL KE 7646, which includes 15 weight % of STABAXOL P100.

It will be understood that other hydrolytic stabilizing agents may also be used and that the invention is not necessarily limited to carbodiimide hydrolytic stabilizing agents.

Inorganic Filler

The polyester blend composition optionally further comprises inorganic filler. Accordingly, the polyester blend may further incorporate particles of various inorganic substances such as titanium dioxide, silicon oxide, calcium carbonate, silicon nitride, clay, talc, kaolin, and zirconium acid, particles of cross-linked macromolecular compounds, or particles of various metals as fillers. The blends may also comprise other known additives such as antioxidants, metal ion sequestrants, ion exchangers, anti-staining agents, light-resisting agents, flame retardants, inclusion compounds, antistatic agents, various coloring agents, waxes, silicone oil, processing aids, various fluorinated surfactants, various reinforcing fibers and the like well known in the polymer art.

Process for Making the Composition

The above compositions may be compounded by means well known in the art. For example, melt-blending in an extruder as described in the Examples may be employed.

Incorporation of the non-modified fluoropolymer and modified fluoropolymer, as described above, in the polyester composition can be accomplished simply by selecting one member or a mixture of two or more members from among the examples of the non-modified fluoropolymer mentioned above and a modified fluoropolymer and causing them to be contained in the polyester. For example, addition of the non-modified fluoropolymer and the modified fluoropolymer to the polyester for incorporation therein can be achieved by adding the fluoropolymers to the polyester in a molten state either during or immediately after the reaction of polycondensation, and kneading the resultant mixture, or by a method which comprises adding chips, pellets or particles of the non-modified fluoropolymer and modified fluoropolymer to chips, pellets or particles of the polyester resin and kneading by an extruder.

In the case of a random or block copolymer of polyperfluoroalkyl acrylate, polyperfluoroalkylmethacrylate, perfluoroalkyl acrylate and/or perfluoroalkyl methacrylate with an acrylate and/or methacrylate optionally including a hydroxyalkyl group, this copolymer may be dissolved in a suitable organic solvent such as ketone or acetic ester and then the resultant solution may be added to the polyester. It is also permissible to mix, in a suitable ratio, a fluoropolymer having fluorine mainly in the main chain of polymer molecule with a fluoropolymer having fluorine in the side chain of polymer molecule with a modified fluoropolymer, and add the resultant mixture to the polyester.

Fibers

Fibers may be prepared directly from extrusion processes including centrifugal spinning, melt-spinning, spunbonding and melt-blowing.

In centrifugal spinning, fibers are formed as a polymer melt is accelerated from a rapidly rotating source. Molten material from a furnace is transferred into a rotating spinner, and the fibers are produced as centrifugal force extrudes the material through small holes in the side of the spinning device.

In melt spinning, the fiber-forming substance is melted for extrusion through a spinneret, essentially a plate having a plurality of orifices therein. The orifices form the molten polymer into filaments that are then cooled or quenched by a cooling medium, typically conditioned air, and then further processed as known in the art. Filaments can also be formed by an extrusion process, characterized by extrusion through a spinneret into a relatively short air gap followed by forced quenching, typically via a water bath, then further processed as known in the art. Melt-spun or extruded fibers can be extruded from the spinneret in different cross-sectional shapes (see below). Drawing may be effected by wrapping the moving threadline around sets of rotating rolls running at controlled temperature and speeds or by passing the moving threadline through an oven between the sets of rotating rolls. Depending on the specific process and subsequent processing steps, product can be collected as monofilaments, yarn, tow or nonwoven (e.g. spunbond). See Fibers from Synthetic Polymers, Rowland Hill, ed., Elsevier Publishing Co., NY, 1953 and Recent Advances in Spinning, Extruding and Processing of Fibers, Chemical Technology Review No. 159, J. S. Robinson, ed., p. 56, Noyes Data Corp. Park Ridge, N.J., 1980 for general references regarding melt-spun fibers.

Spunbonding is the direct laydown of nonwoven textile webs from fibers as they are melt-spun. Continuous filaments are extruded through a spinneret, accelerated (via rolls or jets) and laid down onto a moving belt to form a nonwoven sheet. Bonding occurs at molten fiber crossover points.

Meltblowing is another direct laydown process in which fibers are extruded through a die tip, attenuated (and fractured) by hot, high velocity air, and deposited onto a moving belt or screen to form a textile web of fine (low denier) fibers.

Both spunbond (S) and meltblown (M) textile webs, after being formed, can be further bonded and/or patterned by calendering. Multiple layered nonwovens (e.g. SMS, SMMS, SMMMS) can also be prepared from fibers of this invention.

Preferred are melt-spun or extruded fibers, as described above.

The monofilament fiber may comprise a single composition throughout the cross-section of the fiber.

Alternatively, the monofilament fiber may be a core-sheath composite monofilament having a core made of polyester not containing fluoropolymers and a sheath made of the polyester blend containing at least one fluoropolymer and at least one fluoropolymer comprising compatibilizing side groups. Of note is a composite monofilament wherein the combination of the at least one fluoropolymer and the at least one fluoropolymer comprising compatibilizing side groups is greater than one weight % of the composition. The monofilament fiber may also be a core-sheath composite monofilament having a core and a sheath both made of compositions comprising polyester and at least one fluoropolymer and at least one fluoropolymer comprising compatibilizing side groups wherein the core and the sheath are differentiated from each other, for example by the amounts and/or the kind of the fluoropolymer and/or fluoropolymer comprising compatibilizing side groups respectively in the core and sheath. Such core-sheath monofilaments may be desirable because the composition providing improved stain resistance may be preferentially localized near the surface of the fiber.

Preferred are monofilament fibers wherein the fluoropolymer component comprises about 10 weight % or more modified fluoropolymer and up to about 90 weight % non-modified fluoropolymer, weight percentages being based on total weight of the fluoropolymers.

The monofilament is a continuous line of one thread having any desired cross-sectional shape, such as round, trilobal, pentalobal, octalobal, flattened figure, square, triangle, pentagon and polygons, dumbbell, cocoon and others. The term “flattened figure” as used herein refers to an ellipse or a rectangle. The term embraces not merely a geometrically defined exact ellipse and rectangle but also shapes roughly similar to an ellipse and a rectangular and a shape obtained by rounding the four corners of a rectangle. The length of a line along the center of gravity of the cross section of the monofilament may be from 0.10 to 2.5 mm.

When this monofilament is intended as a warp in a fabric, such as that intended for a papermaking belt, the monofilament having the cross section of a flattened figure may be advantageously used for providing a flatter belt. When the cross-sectional shape of the polyester blend monofilament is a dumbbell or a cocoon when used in a papermaking belt, the paper may be produced with a better finish because the air-passing property of the belt is adjusted and the distribution of the degree of dryness of paper may be made more uniform.

Optionally, such known additives as water-repellent agents, oil-repellent agents and/or lubricants may be imparted to the surface of the monofilament.

Nonwoven textiles can be prepared from melt-spun fibers as described above. Preferred nonwoven textiles are prepared from the preferred and notable compositions and fibers above.

Woven or knitted textiles can be prepared from melt-spun or extruded fibers as described above. In general, woven fabrics may have a tighter construction than knitted fabrics.

Preferred woven or knitted textiles are prepared from the preferred and notable compositions and fibers described above.

Fabrics or textiles prepared from the blends described herein exhibit improved soil-release characteristics compared to nonmodified polyester blends. As such, the textiles are useful in a wide variety of applications where such characteristics are desirable.

The monofilament fiber described above provides a desirable filament for a fabric for a belt used in papermaking, such as a drier canvas that is used for the production of medium-grade paper, newspaper, and various hard boards. When fibers comprising blends described herein are used in papermaking belts, staining and deterioration of the belt during the process of papermaking is alleviated, the quality of produced paper is stabilized, and the cycle of cleaning and the service life of the canvas are extended. Preferred papermaking belts are prepared from the preferred and notable compositions, fibers and fabrics described above.

A fabric formed from a plurality of woven monofilament fibers comprising the composition described herein can be fabricated into a papermaking belt. For example, strip of fabric can be joined at the ends to from a continuous loop that can be used as a belt in papermaking. The size of the belt is dependent on the particular papermaking machine it is intended for. The belt may be from about 1 meter (or less) to several meters wide and several meters in length.

Although textiles comprising the compositions are primarily described herein as useful for papermaking belts, many other applications are contemplated. The compositions and textiles described herein are useful for applications where resistance to soiling, fouling and other contamination is desirable.

Polyester blend yarns prepared as described herein can be woven into fabrics used in applications such as filters, tarpaulins, sails, boat tops, covers, awnings, tents, escape slides, canopies, banners, construction (e.g. roofing) membranes, machine belts, liners for luggage or packaging, heavy duty sacking, carpet backing, book covers, footwear, upholstery for use in home furniture, motor vehicles, boats, aircraft and the like, and apparel. Knitted fabrics can be used for sacking for use in carrying bulky materials such as groceries, firewood and the like; and construction and industrial netting.

Nonwoven fabrics can be used in medical apparel such as hats, gowns, booties, personal protective equipment including masks and the like, hygiene protective furnishings such as drapes, covers, blankets and the like, packaging, durable paper, wipes, wraps, banners, upholstery, apparel, filters, and liners.

It should be understood that any polyester resin and melt extrudable fluoropolymer resin suitable for the functional requirements described herein may be used, and any examples provided herein are not intended to limit the present invention to those particular resins or to those particular amounts, unless otherwise indicated. While the invention has been particularly shown and described with reference to the preferred embodiments thereof, it will be understood by those skilled in the art that various changes in form and details may be made without departing from the spirit and scope of the invention.

The following Examples are merely illustrative, and are not to be construed as limiting to the scope of the invention described and/or claimed herein.

### EXAMPLES

Materials Used

Resin A: An ETFE fluoropolymer, available from DuPont under the tradename TEFZEL 200.
Resin B: An ETFE fluoropolymer with maleic anhydride graft (a compatibilizing fluoropolymer), available from DuPont under the tradename TEFZEL 2202.
Resin C: A 0.83 IV PET polymer, available from DuPont under the tradename CRYSTAR 5005, pre-dried overnight in a vacuum oven at 110° C. prior to extrusion.
Resin D: A Nylon 6 polymer, available from BASF under the tradename CAPRON 135, pre-dried overnight in vacuum oven at 70° C. prior to extrusion.
Resin E: A maleic anhydride grafted low density polyethylene, available from available from DuPont under the tradename BYNEL 4288.
Resin F: A polyolefin with maleic anhydride graft, available from DuPont under the tradename FUSABOND 493D.
Resin G: A polyethylene acrylate epoxide copolymer, available from DuPont under the tradename ELVALOY AS.
Resin H: A modified ethylene alkyl acrylate resin, available from DuPont under the tradename APPEEL 20D808.
Resin I: A 0.95 IV PET homopolymer available from DuPont as CRYSTAR 5154.
Control: A 0.72 IV PET homopolymer available from DuPont as CRYSTAR 5147.
Additive J: An antioxidant commercially available as IRGANOX 1010.
TiO₂: TiO₂ in ETFE available as TIPURE 150 available from DuPont.
   Test Methods

The test methods used in the Examples are as follows:

Abrasion Test (cycles to failure). The abrasion test employs a rotating 9 inch circumference drum having 15 steel wires of 0.029 inch diameter secured at the drums circumference under a tension of 45±2 kilograms. The steel wires extend parallel to the axis of the drum. Monofilaments tested for abrasion resistance are secured to a fixed point at one end and to an 850-gram weight at the other end. The monofilaments are placed perpendicular to and in contact with the steel wires so as to be in contact with 4 of them. The drum is then rotated at 60 revolutions per minute. The number of rotations before break is recorded in Table 2.

Tenacity, Elongation at Break, and Young's Modulous. Properties reported in Table 2 were measured in accord with ASTM D2256.

General Compounding (Blending) Procedure.

The materials were melt-blended in a 28-mm twin screw Werner and Pfleiderer extruder equipped with a high shear mixing screw, vacuum port over heating zone 4 and a 3/16-inch diameter 1-hole die and quenched in a water bath to provide the compositions summarized in Table 1. The extrudate was cut into pellets with a Conair #7C cutter. Temperature set points were: feed zone, room temperature; zone 1, 250° C.; zone 2, 265° C.; zone 3, 270° C.; zone 4, 270° C.; zone 5, 270° C.; adapter, 270° C.; and die, 270° C.

### Example 1

Resins A and B were compounded together. The two-component blend was then pellet blended with the other resins and melt blended as described above to produce pellets.

### Example 2

Resin A and B were compounded together. That compound was then pellet blended with the other resins and melt compounded to produce pellets.

### Example 3

Resins A and B were melt compounded with TiO₂. Those pellets were then melt compounded with resins E, G, C and Additive J.

### Example 4

Resins A and B were melt compounded and subsequently pellet blended with Resin C and then melt compounded.

### Example 5

Resins A and B were melt compounded. Those pellets were then melt compounded with Resin C.

### Example 6

Resins A and B were melt compounded. Those pellets were pellet blended and subsequently melt compounded with Resins C and H.

### Example 7

Resins A and B were melt blended and the pellets were blended with resins D, F, G and I. That blend was then melt compounded.

TABLE 1

| Material and weight % | Example | | | | | | |
|---|---|---|---|---|---|---|---|
| loadings | 1 | 2 | 3 | 4 | 5 | 6 | 7 |
| Resin A | 4.0 | 3.0 | 2.4 | 4.0 | 7.0 | 4.0 | 6.2 |
| Resin B | 6.0 | 2.0 | 1.6 | 6.0 | 3.0 | 6.0 | 1.5 |
| TiO₂ in ETFE | — | 6.1 | 4.9 | — | — | — | — |
| Resin D | 1.9 | 1.9 | 1.9 | — | — | — | 3.4 |
| Resin F | 1.0 | 1.0 | 0.9 | — | — | — | 1.8 |
| Resin E | — | — | 6.5 | — | — | — | — |
| Resin G | 1.0 | 1.0 | 1.0 | — | — | — | 1.0 |
| Resin H | — | — | — | — | — | 2.0 | — |
| Resin I | — | — | — | — | — | — | 86.1 |
| Additive J | — | 0.2% | — | — | — | — | — |
| Resin C | 86.1 | 84.8 | 80.8 | 90.0 | 90.0 | 88.0 | — |
| Total | 100 | 100 | 100 | 100 | 100 | 100 | 100 |

General Procedure for Making Monofilament

Polyesters and polyester-based blends with fluoropolymers are dried for 2 or more hours between 120 and 180° C., usually for 4 to 10 hours at 140 to 160° C. Dried resin is continuously fed into an extruder where it is melted, preferably at temperatures below about 320° C., and forced through small holes to form a strand. The strand is cooled in air or water to freeze the molten polymer and then reheated to a temperature around the glass transition temperature of the polyester, usually around 80° C. Tension is simultaneously placed on the heated fiber to extend it to 3 to 6 times it original length, resulting in a fiber diameter reduction. This drawing process can be done in one or multiple steps.

The resulting improved soil-resistant polyester monofilament may be woven into textiles, particularly textiles useful in papermaking belts.

Example Process for Making Monofilaments

The dried pellets of the above Examples and the Control where continuously fed into an extruder and melt extruded to form strands. The strands were cooled in water to freeze the molten polymer and then reheated under tension to form monofilament fibers having the denier indicated in Table 2. The resulting monofilament fibers were tested with results reported in Table 2.

TABLE 2

| | | Abrasion | | | Young's |
|---|---|---|---|---|---|
| | | Cycles to | Tenacity | Elongation at | Modulous |
| Example | Denier | Failure | (g/d) | Break (%) | (g/d) |
| Control | 2290 | 2400 | 4.3 | 21 | 76 |
| 1 | 2291 | 1900 | 4.2 | 23 | 76 |
| 2 | 5100 | 8000 | 3 | 17 | 86 |
| 3 | 4800 | 8000 | 3 | 20 | 78 |
| 4 | 2300 | 2100 | 4.1 | 21 | 83 |
| 5 | 2277 | 2000 | 4.0 | 23 | 79 |
| 6 | 2372 | 1600 | 3.9 | 24 | 74 |
| 7 | 2150 | 1600 | 4.7 | 20 | 82 |

Having thus described and exemplified the invention with a certain degree of particularity, it should be appreciated that the following claims are not to be so limited but are to be afforded a scope commensurate with the wording of each element of the claim and equivalents thereof.

What is claimed is:

1. A composition comprising
(a) at least about 45 weight % of a polyester resin;
(b) up to about 55 weight % of a fluoropolymer component comprising at least one modified fluoropolymer, said modified fluoropolymer being a fluoropolymer having compatibilizing side groups, and optionally comprising at least one non-modified fluoropolymer, said non-modified fluoropolymer being one that does not have compatibilizing side groups, the weight percentages based on the total weight of the composition; optionally comprising (c), (d), (e), or combinations thereof, wherein
(c) is at least one additional polymeric resin that is not a polyester resin, a modified fluoropolymer or a non-modified fluoropolymer;
(d) is a hydrolytic stabilizer; and
(e) is an inorganic filler.

2. The composition of claim 1 wherein the compatibilizing side groups are selected from the group consisting of carboxylic, sulfonic, and phosphonic acid moieties and diacids, esters, and anhydrides thereof.

3. The composition of claim 4 wherein the modified fluoropolymer is prepared by grafting at least one comonomer comprising a compatibilizing side group selected from the group consisting of dialkyl maleate esters, monoalkyl maleate esters, maleic anhydride, halogen-substituted maleic anhydrides, itaconic anhydride, citraconic anhydride, glutaconic anhydride, and ester-functional fluoro(vinyl ether) or styrene comonomers onto a fluoropolymer.

4. The composition of claim 4 wherein the modified fluoropolymer is prepared by copolymerization of at least one comonomer comprising a compatibilizing side group selected from the group consisting of dialkyl maleate esters, monoalkyl maleate esters, maleic anhydride, halogen-substituted maleic anhydrides, itaconic anhydride, citraconic anhydride, glutaconic anhydride, and ester-functional fluoro(vinyl ether) or styrene comonomers with at least one fluorine-containing comonomer.

5. The composition of claim 4 wherein the compatibilizing side groups are derived from maleic anhydride.

6. The composition of claim 1 wherein the compatibilizing side groups are epoxy-containing moieties that are derived from glycidyl-containing moieties selected from the group consisting of glycidyl acrylate or glycidyl methacrylate, and glycidyl vinyl ethers of from 1 to 10 carbon atoms; or are mono-epoxy substituted di-olefins of from 4 to 12 carbon atoms.

7. The composition of claim 1 wherein the polyester resin comprises polyethylene terephthalate, polypropylene terephthalate or polybutylene terephthalate.

8. The composition of claim 1 wherein the fluoropolymer component comprises about 10 weight % or more modified fluoropolymer and up to about 90 weight % non-modified fluoropolymer, weight percentages being based on total weight of the fluoropolymers.

9. The composition of claim 8 wherein the non-modified fluoropolymer is an ethylene tetrafluoroethylene copolymer.

10. The composition of claim 9 wherein the modified fluoropolymer is derived from ethylene tetrafluoroethylene.

11. The composition of claim 10 wherein the modified fluoropolymer is a graft fluoropolymer derived from the grafting of maleic anhydride to an ethylene tetrafluoroethylene base polymer.

12. The composition of claim 1 wherein the at least one additional polymeric resin is selected from the group consisting of polyethylene homopolymers and copolymers, polyethylene comprising compatibilizing side groups derived from maleic anhydride or epoxide, polyamides, ethylene α,β ethylenically unsaturated carboxylic acid copolymers and ionomers thereof, and ethylene/alkyl (meth)acrylate copolymers.

13. The composition of claim 12 comprising at least two additional polymeric resins wherein one additional polymeric resin is a polyethylene comprising compatibilizing side groups derived from an epoxide and one additional polymeric resin is a polyamide.

14. The composition of claim 1 wherein the hydrolytic stabilizer is a carbodiimide.

15. A monofilament fiber comprising a composition according to claim 1.

16. The monofilament fiber of claim 15 that is a core-sheath composite monofilament having a core made of polyester not containing fluoropolymers and a sheath comprising the composition.

17. The monofilament fiber of claim 15 wherein the fluoropolymer component comprises about 10 weight % or more modified fluoropolymer and up to about 90 weight % non-modified fluoropolymer, weight percentages being based on total weight of the fluoropolymers.

18. A fabric comprising a composition according to claim 1.

19. The fabric of claim 18 formed from a plurality of woven monofilament fibers comprising the composition.

20. The fabric of claim 19 that is fabricated into a papermaking belt.
